(19) United States
(12) Patent Application Publication
(10) Pub. No.: US 2005/0263011 A1
(43) Pub. Date: Dec. 1, 2005

(54) Cookware apparatus

(76) Inventor: Eric Golding, Yorba Linda, CA (US)

Correspondence Address: S. Michael Bender, P.O. Box 530-399, St. Petersburg, FL, 33747, US

(21) Appl. No.: 11/142,517

(22) Filed: Jun. 1, 2005

Related U.S. Application Data
(60) Provisional application No. 60/575,782, filed on Jun. 1, 2004.

(51) Int. Cl. A47J 37/10

(52) U.S. Cl. 99/422

(57) ABSTRACT

A cookware apparatus includes a container portion which includes a container bottom and a container side wall which extends upward from the container bottom. The container side wall has a side wall top and has an exterior side wall surface. A spout portion is connected to the container side wall between the side wall top and the container bottom. The spout portion extends outward from the exterior side wall surface along a spout axis and is in fluid communication with an interior container space of the container portion. A handle is connected to the container side wall and extends along a longitudinal handle axis which extends transversely with respect to the spout axis. Use of the invention permits a user to pour off unwanted liquids from the interior container space without worrying about also pouring out desired solid food from the interior container space. The apparatus can be in the form of a frying pan, skillet, or cooking pot.

### CROSS-REFERENCE TO RELATED APPLICATION

This application claims priority based upon my copending Provisional Application Ser. No. 60/575,782; filed Jun. 1, 2004.

### BACKGROUND OF THE INVENTION

1. Field of the Invention

The present invention relates generally to cookware, and, more particularly, to cookware especially adapted for draining oil or grease from the cookware.

2. Description of the Prior Art

When a cook uses cookware for cooking with oil or grease, it is often desirable to remove some of the hot oil grease from the cookware. In this respect, throughout the years, a number of innovations have been developed relating to cookware that have features for draining oil or grease from the cookware, and the following U.S. patents are representative of some of those innovations: U.S. Pat. Nos. 2,157,303, 3,218,959, and 4,352,324.

U.S. Pat. No. 2,157,303 discloses a draining frying pan which includes a funnel-like projection which projects outward from a side of the frying pan and feeds into a cylindrical receptacle that receives drainage from the frying pan. The cylindrical receptacle is relatively high and wide. Actually the cylindrical receptacle extends below the floor of the frying pan. As a result, the frying pan is supported by an elevated support structure. For purposes of simplicity and economy, it would be desirable if drainable cookware were provided that does not have a relatively high and wide cylindrical drainage receiving receptacle that is supported by a funnel-like side projection from the cookware.

U.S. Pat. No. 3,218,959 discloses a machine for making potato chips that includes a cooking oil containing receptacle that has drainage valve located at the bottom of the receptacle. Having a drainage valve located at the bottom of the receptacle precludes the use of the receptacle on a heat source that would placed under the receptacle. Such a heat source could include an electric heating element or a gas flame. In addition, having a drainage valve brings up potential problems that can occur when a valve is employed. Valves often leak after extended use. Therefore, to avoid problems discussed hereinabove, it would be desirable if drainable cookware were provided that does not employ a drainage valve.

U.S. Pat. No. 4,352,324 discloses a frying pan that has a removable grease catcher. The frying pan has a handle, and the removable grease catcher is located along the longitudinal axis of the handle. A spout is located in the frying pan, and that spout is also located along the longitudinal axis of the handle. Therefore, in order to drain grease from the frying pan, the frying pan has to be tilted towards the handle. Inherently, a user may not want to pour hot grease out from a frying pan in a direction toward the user. For purposes of safety and comfort, it would be desirable if drainable cookware were provided that does not include a drainage spout that is located along the longitudinal axis of the cookware handle.

Each of U.S. Pat. No. 3,604,340 and U.S. Pat. No. 4,052,934 may be of interest for their respective disclosures of open mesh racks that hold food and that are placed in a quantity of oil.

Thus, while the foregoing body of prior art indicates it to be well known to use cookware that has oil and grease drainage features, the prior art described above does not teach or suggest a cookware apparatus which has the following combination of desirable features: (1) does not have a relatively high and wide cylindrical drainage receiving receptacle that is supported by a funnel-like side projection from the cookware; (2) does not employ a drainage valve; and (3) does not include a drainage spout that is located along the longitudinal axis of the cookware handle. The foregoing desired characteristics are provided by the unique cookware apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides cookware apparatus which includes a container portion which includes a container bottom and a container side wall which extends upward from the container bottom. The container side wall has a side wall top and has an exterior side wall surface. A spout portion is connected to the container side wall between the side wall top and the container bottom. The spout portion extends outward from the exterior side wall surface along a spout axis and is in fluid communication with an interior container space of the container portion. A handle is connected to the container side wall and extends along a longitudinal handle axis. The spout axis extends transversely with respect to the longitudinal handle axis. Use of the invention permits a user to pour off unwanted liquids from the interior container space without worrying about also pouring out desired solid food from the interior container space.

With one embodiment, the container side wall is oriented with respect to the container bottom at an obtuse angle. This embodiment can be regarded as a frying pan or skillet.

With another embodiment, the container side wall is oriented with respect to the container bottom at a right angle. This embodiment can be regarded as a cooking pot.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved cookware apparatus which has all of the advantages of the prior art and none of the disadvantages.

It is another object of the present invention to provide a new and improved cookware apparatus which may be easily and efficiently manufactured and marketed.

It is a further object of the present invention to provide a new and improved cookware apparatus which is of durable and reliable construction.

An even further object of the present invention is to provide a new and improved cookware apparatus which is susceptible of a low cost of manufacture with regard to both materials and labor, and which accordingly is then susceptible of low prices of sale to the consuming public, thereby making such cookware apparatus available to the buying public.

Still yet a further object of the present invention is to provide a new and improved cookware apparatus which does not have a relatively high and wide cylindrical drainage receiving receptacle that is supported by a funnel-like side projection from the cookware.

Still another object of the present invention is to provide a new and improved cookware apparatus that does not employ a drainage valve.

Yet another object of the present invention is to provide a new and improved cookware apparatus which does not include a drainage spout that is located along the longitudinal axis of the cookware handle.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a first embodiment of the cookware apparatus of the invention.

FIG. 2 is an enlarged partial cross-sectional view of the embodiment of the cookware apparatus shown in FIG. 1 taken along line 2-2 of FIG. 1.

FIG. 3 is a side view showing a second embodiment of the cookware apparatus of the invention.

FIG. 4 is an enlarged partial cross-sectional view of the embodiment of the cookware apparatus shown in FIG. 3 taken along line 4-4 of FIG. 3.

FIG. 5 is an elevated perspective view of the embodiment of the invention shown in FIG. 1, wherein the rear side of the side-wall spout is visible.

FIG. 6 is an elevated perspective view of the embodiment of the invention shown in FIG. 1, wherein the front side of the side-wall spout is visible.

### DESCRIPTION OF THE PREFERRED EMBODIMENT

With reference to the drawings, a new and improved cookware apparatus embodying the principles and concepts of the present invention will be described.

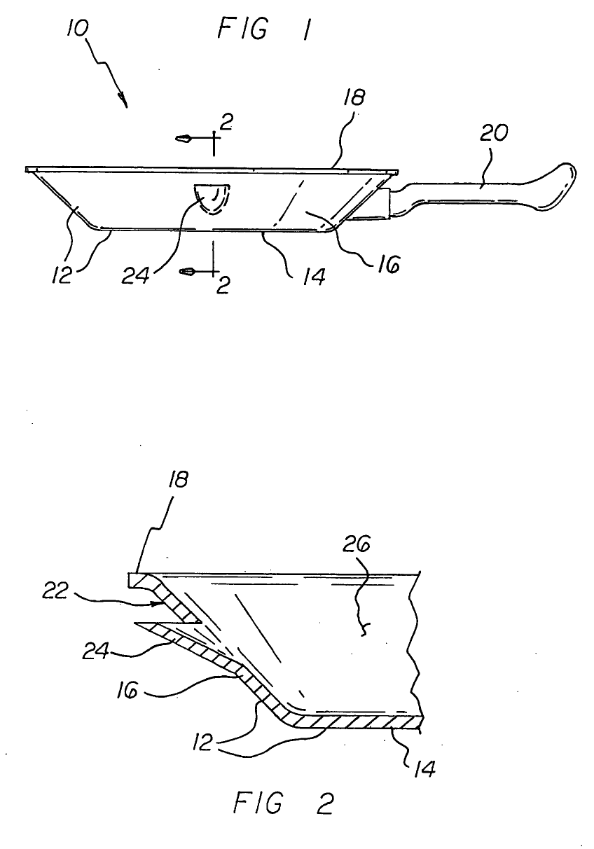

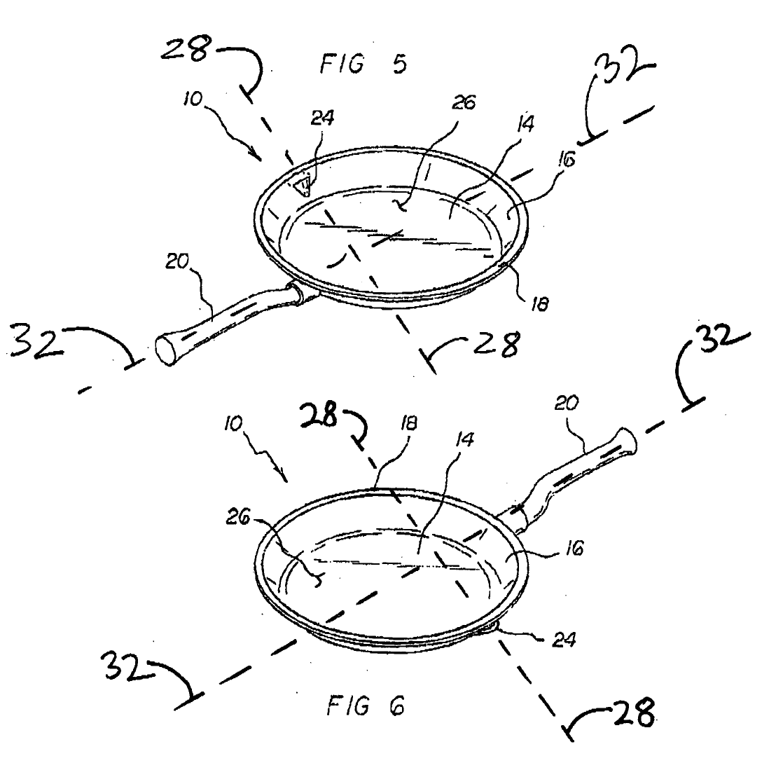

Turning to FIGS. 1, 2, 5, and 6, there is shown a first embodiment of the cookware apparatus of the invention generally designated by reference numeral 10. In the first embodiment, cookware apparatus 10 includes a container portion 12 which includes a container bottom 14 and a container side wall 16 which extends upward from the container bottom 14. The container side wall 16 has a side wall top 18 and has an exterior side wall surface 22. A spout portion 24 is connected to the container side wall 16 between the side wall top 18 and the container bottom 14. The spout portion 24 extends outward from the exterior side wall surface 22 along a spout axis 28 and is in fluid communication with an interior container space 26 of the container portion 12. A handle 20 is connected to the container side wall 16 and extends along a longitudinal handle axis 32. The spout axis 28 extends transversely with respect to the longitudinal handle axis 32. The transverse angle between the spout axis 28 and the longitudinal handle axis 32 can be approximately 90 degrees.

In the embodiment of the invention shown in FIGS. 1, 2, 5, and 6, the container side wall 16 is oriented with respect to the container bottom 14 at an obtuse angle. Such an embodiment of the invention can be considered to be a frying pan or skillet.

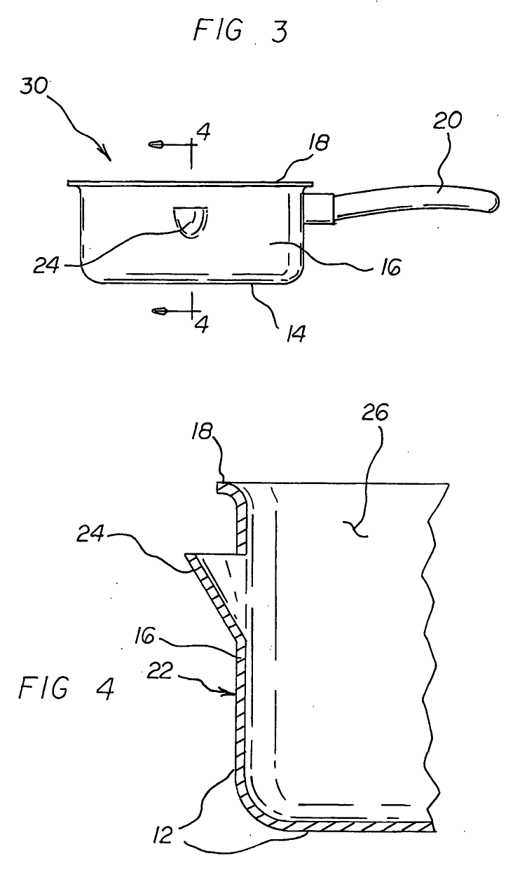

In the second embodiment 30 of the invention shown in FIGS. 3 and 4, the container side wall 16 is oriented with respect to the container bottom 14 at a right angle. Such an embodiment of the invention can be considered to be a cooking pot.

To use either embodiment of the invention, a user grasps the handle 20 and tilts the apparatus so that liquid inside the interior container space 26 reaches the inside opening of the spout portion 24. Then, liquid inside the interior container space 26 can flow out from the interior container space 26, through the spout portion 24, to outside the container portion 12. Employment of the spout portion 24 enables a user to pour out liquids from the interior container space 26 without the user worrying about solid foods in the interior container space 26 from pouring out from the interior container space 26.

The cookware apparatus 10 of the invention is very useful for pouring off liquids, such as liquid fat or grease, from the cookware apparatus 10 when the cookware apparatus 10 is used for frying foods such as ground beef, ground turkey, or bacon. By using the convenient spout portion 24 to pour off liquids, liquids will not run down the container side wall 16 and will not create messy exterior side wall surfaces 22. For convenience, the spout portion 24 can extend outward from the exterior side wall surface 22 by about one-half inch.

The components of the cookware apparatus of the invention can be made from inexpensive and durable metal, glass, and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved cookware apparatus that is low in cost, relatively simple in design and operation, and which may advantageously be used without having a relatively high and wide cylindrical drainage receiving receptacle that is supported by a funnel-like side projection from the cookware. With the invention, a cookware apparatus is provided which does not employ a drainage valve. With the invention, a cookware apparatus is provided which does not include a drainage spout that is located along the longitudinal axis of the cookware handle.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A cookware apparatus, comprising:
a container portion which includes a container bottom and a container side wall which extends upward from said container bottom, wherein said container side wall has a side wall top and has an exterior side wall surface,
a spout portion connected to said container side wall between said side wall top and said container bottom, wherein said spout portion extends outward from said exterior side wall surface along a spout axis and is in fluid communication with an interior container space of said container portion, and
a handle connected to said container side wall, wherein said handle extends along a longitudinal handle axis, and wherein said spout axis extends transversely with respect to said longitudinal handle axis.

2. The apparatus of claim 1 wherein a transverse angle between said spout axis and said longitudinal handle axis is approximately 90 degrees.

3. The apparatus of claim 1 wherein said container side wall is oriented with respect to said container bottom at an obtuse angle.

4. The apparatus of claim 1 wherein said container side wall is oriented with respect to said container bottom at a right angle.
